(19) United States
(12) Patent Application Publication
(10) Pub. No.: US 2013/0219784 A1
(43) Pub. Date: Aug. 29, 2013

(54) LANDSCAPE EDGING ASSEMBLY

(71) Applicant: Jeffrey Evan Larsen, West Jordan, UT (US)

(72) Inventor: Jeffrey Evan Larsen, West Jordan, UT (US)

(21) Appl. No.: 13/572,613

(22) Filed: Aug. 11, 2012

Related U.S. Application Data
(60) Provisional application No. 61/602,113, filed on Feb. 23, 2012.

(51) Int. Cl. A01G 1/08; B23P 17/04

(52) U.S. Cl. 47/33; 29/464

(57) ABSTRACT

Embodiments of the present invention include devices and systems that provide a landscape edging assembly and system. In particular, for example, the landscape edging assembly can comprise a first portion, a second portion, and a barrier. The first portion and the second portion are configured to interface with each other in a way that secures the barrier directly to the first portion and the second portion. The barrier can then be situated to create a barrier for roots underground, while the first portion and second portion can be situated to form the aesthetic portion of the edging assembly.

### CROSS-REFERENCE TO RELATED APPLICATIONS

This application claims the benefit of U.S. Provisional Application No. 61/602,113, filed Feb. 23, 2012, which is incorporated herein by reference in its entirety.

### TECHNICAL FIELD OF THE INVENTION

The present disclosure generally relates to landscaping items, and in particular, to landscape edging assemblies and systems.

### BACKGROUND OF THE INVENTION

As part of many landscape projects, a landscaper may use an edging device or system to separate portions of the landscape. Oftentimes, a landscaper uses the edging device to aesthetically separate a first area of landscape from a second area of landscape. For example, a landscaper may use the edging device to separate a lawn area from a flower bed, or one flower bed from another flower bed. Conventional edging devices are made from a large variety of materials, including wood, composites, plastics, and cement, to name a few.

In addition to using the edging device to provide an aesthetic line to separate one landscape area from another landscape area, a landscaper may want to use the edging device to separate one type of vegetation from another. In other words, a landscaper can use the edging device in an attempt to form a barrier to keep vegetation from one landscape area from spreading and growing in another landscape area. This is often the case in the instance where a lawn portion of landscape abuts a flowerbed.

Conventional edging devices have several drawbacks when used to form a barrier. For example, conventional edging devices often are designed such that the vegetation roots from one landscape area can grow under the edging device, thus allowing the vegetation to break the intended edging device barrier, resulting in the vegetation growing in an undesired landscaped area. Moreover, many conventional landscape devices often break, crack, or otherwise allow vegetation from one section to grow through, around, or over the barrier into an undesired landscape area. This of course results in an unpleasant overall landscape aesthetic, and requires increased maintenance costs to manually remove the unwanted vegetation from a particular landscape area.

In addition to the above drawbacks, conventional landscape edging assemblies do not easily integrate with other landscape equipment commonly installed in connection with a landscape project. For example, many landscape projects require the use of irrigation systems (e.g., water lines, sprinklers, drip lines, etc.). Conventional landscape edging assemblies do not integrate with irrigation systems. In particular, a landscaper often has to run water lines under conventional landscape edging assemblies, or run water lines or drip lines in proximity of landscape edging assemblies. However, because conventional landscape edging assemblies are not integrated with irrigation systems, the water lines, sprinklers, and drip lines are often placed in a random way within the landscape area.

Often, the lack of integration of the irrigation system with the conventional landscape edging assembly results in unsightly and exposed irrigation system components. For example, a landscaper may install a water line to simply run on top of the soil in a flower bed, causing an unpleasant aesthetic. In the same vein, landscapers may attempt to conceal the unsightly irrigation system components under the soil of a flower bed. However, because the placement of the components is random, the landscaper or maintenance crew often damages the irrigation system components when digging because they are unaware of the location of the irrigation system components.

Landscape lighting systems (e.g., spot lighting, backlighting, path lighting, etc.) suffer from a similar lack of integration with conventional landscape edging assemblies. For example, landscape lighting systems usually include some type of electrical wiring to run electricity to the various lighting fixtures incorporated into a landscape project. As with the irrigation water lines, a landscaper often runs the electrical wiring in a fairly random fashion to the various lighting fixtures, and then buries the electrical wiring under the soil to conceal the unsightly nature of exposed electrical wire. This installation pattern often leads to damaged electrical wiring when maintenance workers dig in flower beds and accidentally cut the hidden electrical wiring, resulting in higher maintenance costs and frustration.

What is needed is a landscape edging assembly and system that will provide an effective aesthetic barrier between one or more landscape area as well as an effective vegetation barrier. In addition, what is needed is a landscape edging assembly that is able to integrate with other landscape systems to provide an overall landscaping solution, while at the same time maintaining a preferred aesthetic appearance.

### SUMMARY OF THE INVENTION

Embodiments of the present invention include devices and systems that provide a landscape edging assembly and system. In particular, for example, the landscape edging assembly can comprise a first portion, a second portion, and a barrier. The first portion and the second portion are configured to interface with each other in a way that secures the barrier directly to the first portion and the second portion. The barrier can then be situated to create a barrier for roots underground, while the first portion and second portion can be situated to form the aesthetic portion of the edging assembly.

One example embodiment of the present invention provides a landscape edging assembly that has a first portion with a first portion interface element and a second portion with a second portion interface element. In one example the first portion interface element is a slot channel and the second portion interface element is a corresponding protrusion that is configured to fit within the first portion interface. The landscape edging assembly further comprises a barrier that is secured between the first portion interface element and the second portion interface element. The barrier can provide, among other advantages, a vegetation barrier between a first landscape area and a second landscape area.

In another example embodiment of the present invention, a landscape edging assembly is provided that includes a first portion. Integrated within the first portion is a light device that is positioned to provide illumination directly from the landscape edging assembly. In one example, the light device is powered by electrically connecting to an electrical wire that is at least partially housed within a channel located on the first portion of the landscape edging assembly.

In another example embodiment of the invention, a method of assembling a landscape edging assembly is disclosed. The method includes obtaining a first portion having a first interface element and obtaining a second portion having a second interface element. The method further includes aligning the first interface element with the second interface element and positioning a barrier between the first interface element and the second interface element. The method can then further include causing the first interface element to engage the second interface element, whereby the barrier is secured between the first interface element and the second interface element.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific example implementations thereof which are illustrated in the appended drawings. Understanding that these drawings depict only typical implementations of the invention and are not therefore to be considered to be limiting of its scope, the invention will be described and explained with additional specificity and detail through the use of the accompanying drawings in which:

FIG. 1A illustrates a back view of a landscape edging assembly;

FIG. 1B illustrates a front view of a landscape edging assembly;

FIGS. 1C-1F illustrate an example method of assembling a landscape edging assembly;

FIG. 2 illustrates an example of a landscape edging assembly installed prior to integrating any systems;

FIG. 3 illustrates an example of a landscape edging assembly installed with example integrated systems; and

FIG. 4 illustrates a top view of an example landscape edging assembly after installation.

### DETAILED DESCRIPTION OF THE INVENTION

Embodiments of the present invention include devices and systems that provide a landscape edging assembly and system. In particular, for example, the landscape edging assembly can comprise a first portion, a second portion, and a barrier. The first portion and the second portion are configured to interface with each other in a way that secures the barrier directly to the first portion and the second portion. The barrier can then be situated to create a barrier for roots underground, while the first portion and second portion can be situated to form the aesthetic portion of the edging assembly.

Example embodiments of the landscape edging assembly and system disclosed herein provide a landscape edging assembly that not only provides a pleasing aesthetic appearance to divide two or more landscape areas, but also provides an effective barrier between the two or more areas. In particular, the landscape edging assembly disclosed herein utilizes a unique configuration to securely incorporate a barrier that can be made to be much larger than barriers provided by conventional landscape edge devices. In addition, the barrier cooperates with the landscape edging assembly to form an effective barrier between two or more landscape areas.

In addition, the landscape edging assembly disclosed herein provides a novel assembly system that allows the edging device to be easily assembled at the site of the landscape project. For example, a landscaper can easily prepare the landscape for installation of the edging assembly because the novel configuration allows a sufficient bather to be formed with minimal digging and preparing of the soil.

Furthermore, the landscape edging assembly disclosed herein provides for a landscape edging assembly and system that can be integrated into other landscape equipment commonly installed in connection with landscape projects. For example, the landscape edging assembly disclosed herein can integrate with irrigation systems (e.g., water lines, sprinklers, drip lines, etc.). The integration of the landscape edging assembly with an irrigation system can provide for a more secure irrigation system because many irrigation components can be housed and protected within the landscape edging assembly.

In addition to protecting irrigation components, the landscape edging assembly can provide for an overall landscape that is more aesthetically pleasing with respect to irrigation system components. In particular, because the landscape edging assembly can integrate with irrigation system components, these components can be substantially hidden from a viewer of the overall landscape, thus creating a landscape that is more natural looking, but at the same time providing the necessary irrigation to maintain the landscape area.

Furthermore, similar to the irrigation systems described above, the landscape edging assembly and system described herein can integrate with landscape lighting systems (e.g., spot lighting , backlighting, path lighting, etc.). For example, the landscape edging assembly can house or otherwise protect electrical wiring used to power landscape lighting. Thus, the landscape edging assembly can protect the wiring from accidental damage from landscape crews digging in a flowerbed, for example, as well as conceal the electrical wiring to produce a more natural and aesthetically pleasing look to the landscape area. These and additional advantages will be recognized more completely as additional detail is explained below with reference to the figures.

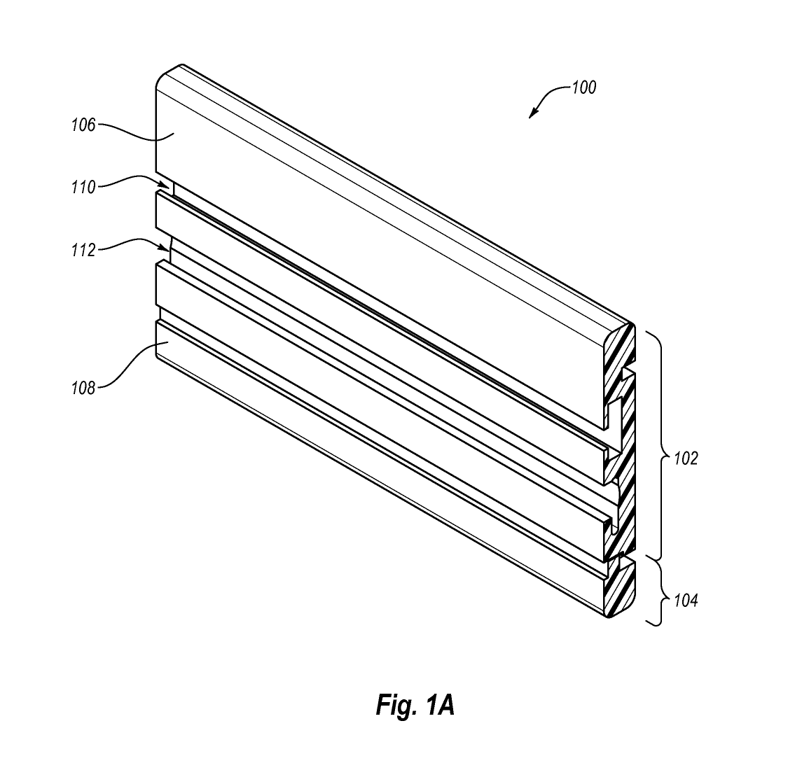

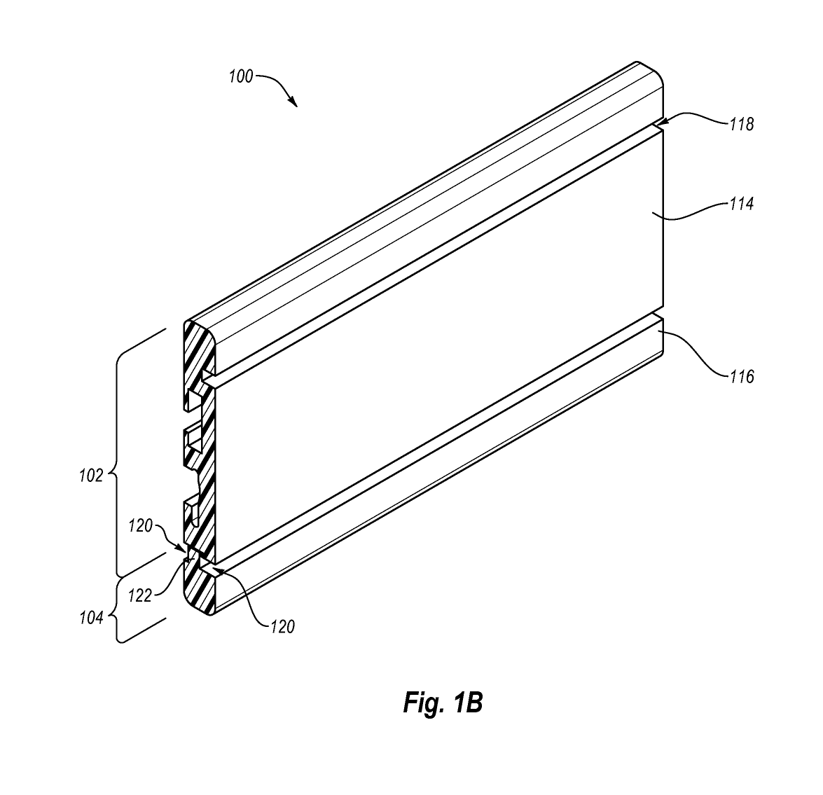

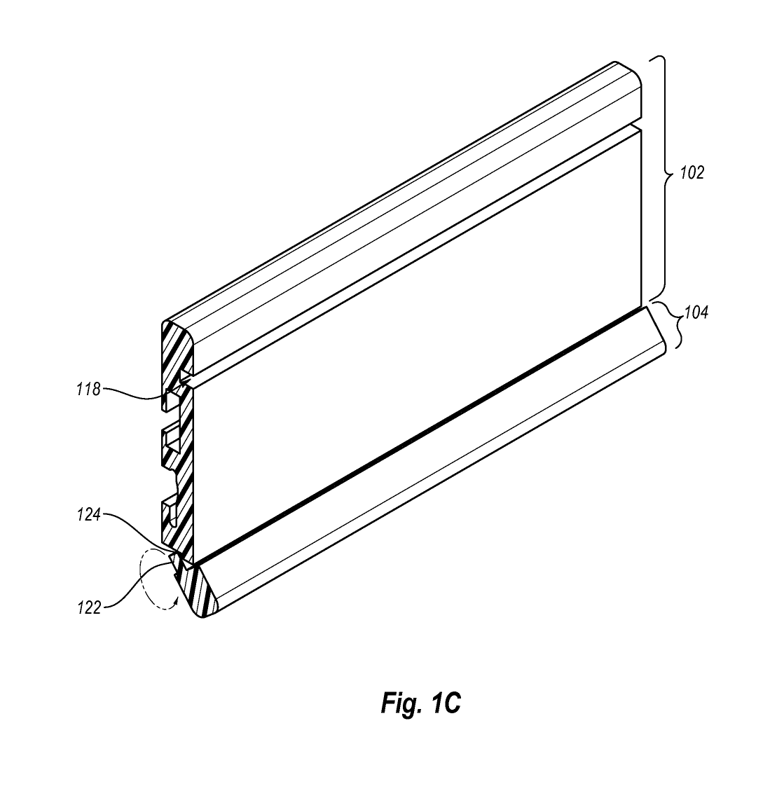

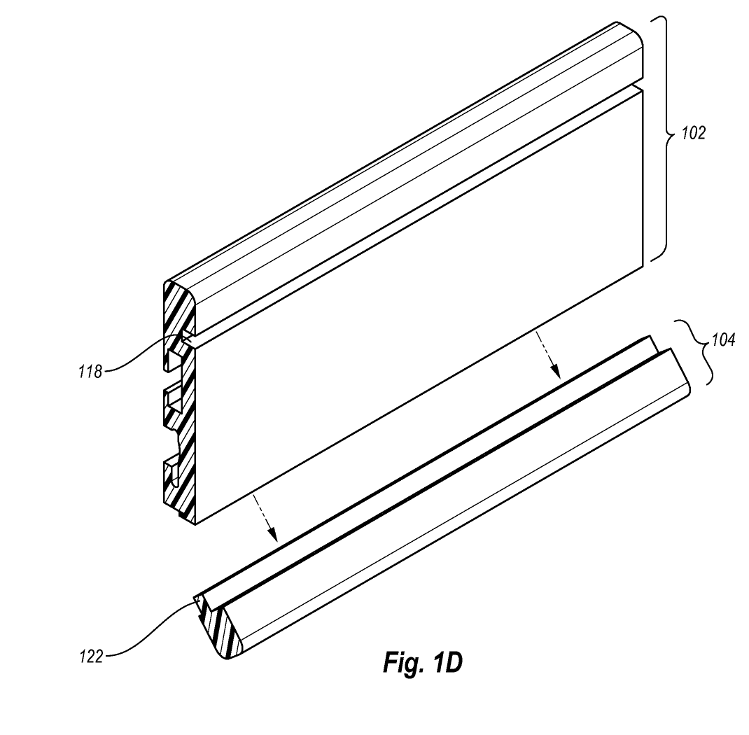

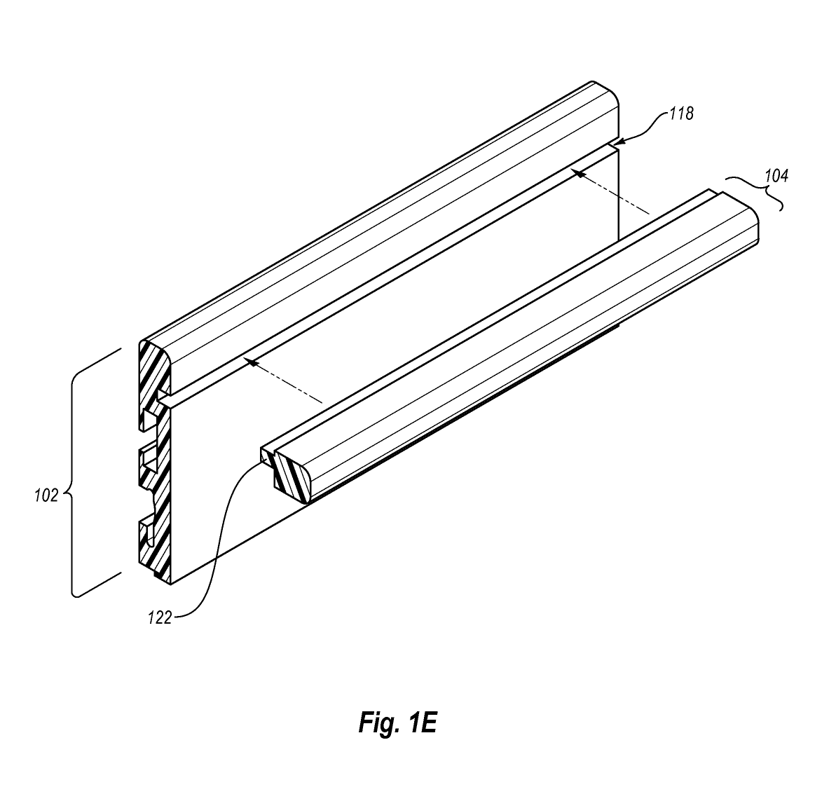

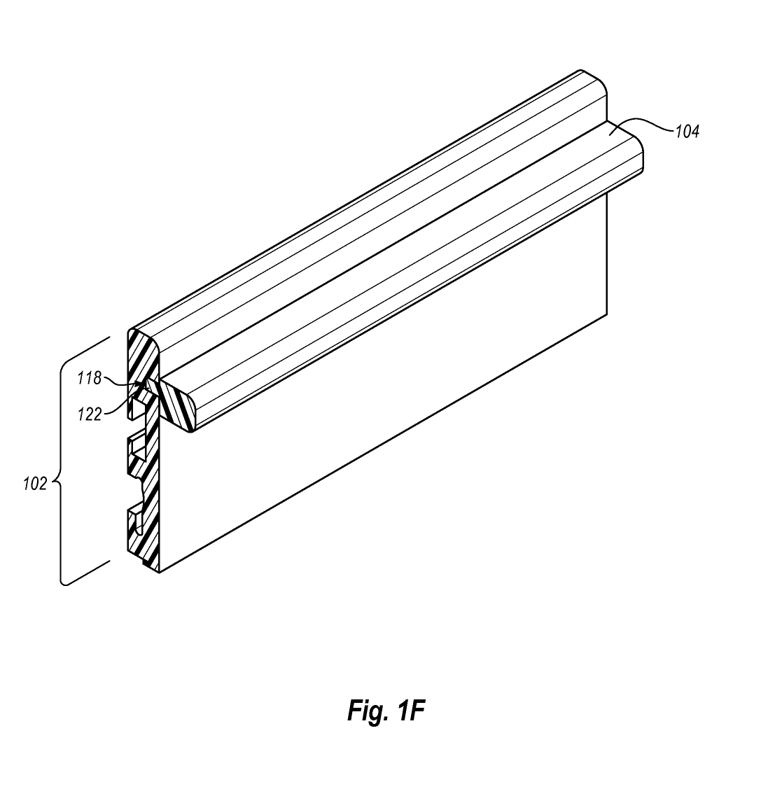

FIG. 1A illustrates a back side view of an example embodiment of a landscape edging assembly 100. In general, a landscape edging assembly 100 is any assembly or device that can be used to separate a first landscape area from a second landscape area. As an overview, an example landscape edging assembly 100 can include a first portion 102, a second portion 104. As illustrated in FIG. 1A, the landscape edging assembly 100 is in a post-manufactured, but pre-assembled state. The landscape edging assembly 100, as illustrated, can be manufactured from a single piece of material. Thus, the first portion 102 and the second portion 104 can be manufactured in one process, saving manufacture time, and material expense. In alternative embodiments, however, the first portion 102 and the second portion 104 may be manufactured from separate pieces of material.

In the post-manufactured pre-assembled state, the first portion 102 and the second portion 104 remain attached together with the second portion 104 attached to one edge of the first portion 102. As illustrated in FIG. 1A, the second portion 104 is attached to the bottom edge of the first portion 102. In alternative embodiments, the second portion 104 may be attached to the top edge of the first portion 102. As will be described further below, in the post-manufacturing state, the second portion 104 is removably attached to the first portion 102, such that the second portion 104 can be separated from the first portion 102 during the assembly process (see discussion with respect to FIGS. 1C-1F).

For example, the landscape edging assembly 100 can be delivered to the landscape site in the post-manufacture pre-assembly state, as illustrated in FIG. 1A. Upon delivery to the landscape site, the landscaper can assemble the landscape edging assembly 100 on-site. In this way, a landscaper can customize the landscape edging assembly 100 to the exact layout as needed in the landscape project.

Alternatively, the landscape edging assembly 100 can be pre-assembled and delivered in fabricated units of various sizes, configurations and shapes. For example, pre-assembled fabricated configurations include circular (e.g., for installing around a tree), various curved sections (e.g., for installing corners of varying radii), various straight sections of different lengths (e.g., for installing straight sections of varying length) and other customizable sizes and configurations. In this way, a landscaper can obtain various pre-assembled fabricated units and combine them together to create a completed landscape edging system for a particular landscape area.

The material of which the landscape edging assembly 100 is made can assist in the assembly and/or installation of the landscape edging assembly 100. The landscape edging assembly can be made from various materials, or combinations of materials. For example, the first portion 102 can be made from a composite material that allows the landscaper to bend, flex and shape the first portion 102 along a landscape edge line. Once the first portion 102 is shaped and secured within the ground, the first portion 102 shape is maintained indefinitely. Generally speaking, the first portion 102 and the second portion 104 are made from the same material, but in some example embodiments the first portion 102 and the second portion 106 can be made from two different materials. Other materials include, but are not limited to, wood, plastics, wood/composite combinations, vinyl and other materials with substantially similar properties. In addition, UV inhibitors can be added to the landscape edging assembly 100 to prevent sun damage to the landscape edging assembly 100.

Returning to FIG. 1A, the landscape edging assembly can include a first portion 102. As illustrated in FIG. 1A, the first portion 102 can have cross-sectional geometric configuration that is substantially rectangular. In particular, the geometric configuration of the first portion 102 can be substantially rectangular such that it produces a wall-like structure to be installed into the ground. In alternative embodiments, the first portion 102 can have varying cross-sectional geometric configurations. For example, the first portion 102 can have a substantially square, rounded, oval, triangular, or any other cross-sectional geometric configuration.

Notwithstanding the variations in cross-sectional geometric configurations, the first portion 102 can have various sizes. In one example embodiment, the first portion 102 has a width of about ½ inches, and a height of about six inches. In alternative embodiments, the first portion 102 can have various height and width dimensions depending on the overall purpose of the landscape edging assembly 100. For example, if the first portion 102 is to be installed substantially underground, then the height may range from about four inches to about eight inches. However, if the landscaper desires to have a significant portion of the first portion 102 above ground, then the height of the first portion 102 can range from about eight inches to about sixteen inches, depending on how much of the first portion 102 is desired to raise up above the ground.

In a similar fashion, the width of the first portion 102 can vary depending on the overall aesthetic desired. For example, a landscape owner may desire a wider look to the landscape edging assembly 100, and therefore the width of the first portion 102 can be increased and range from about ½ of an inch to about two inches. In addition, and as will be explained further below, the width of the second portion 104 can also be adjusted to achieve a desired overall width of the landscape edging assembly 100.

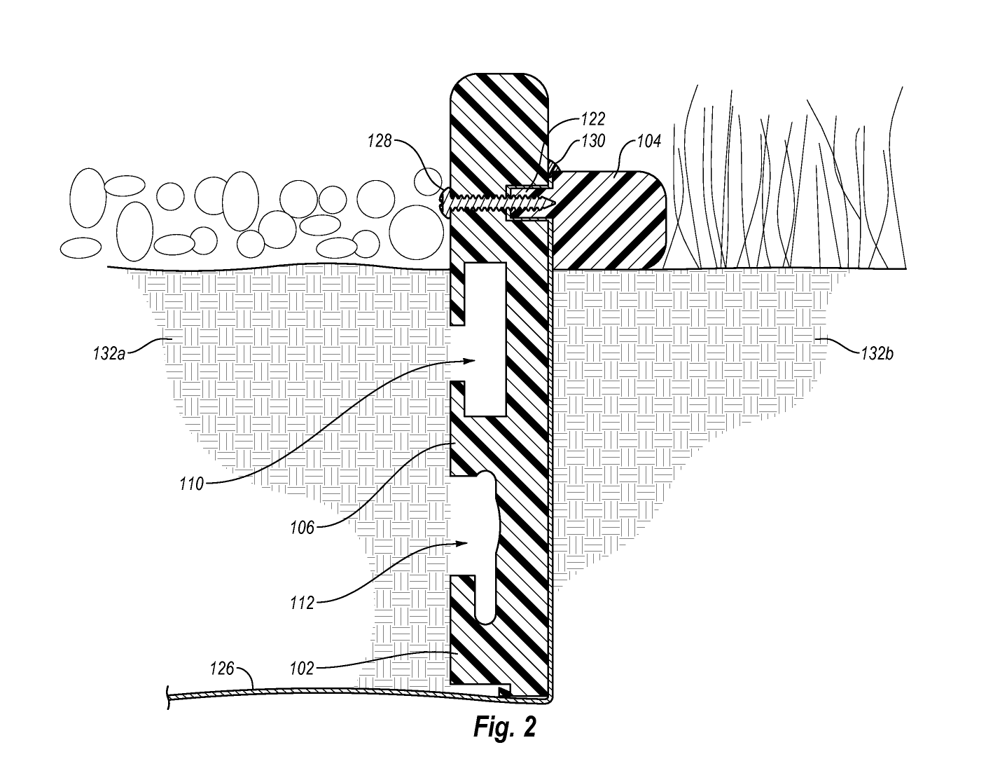

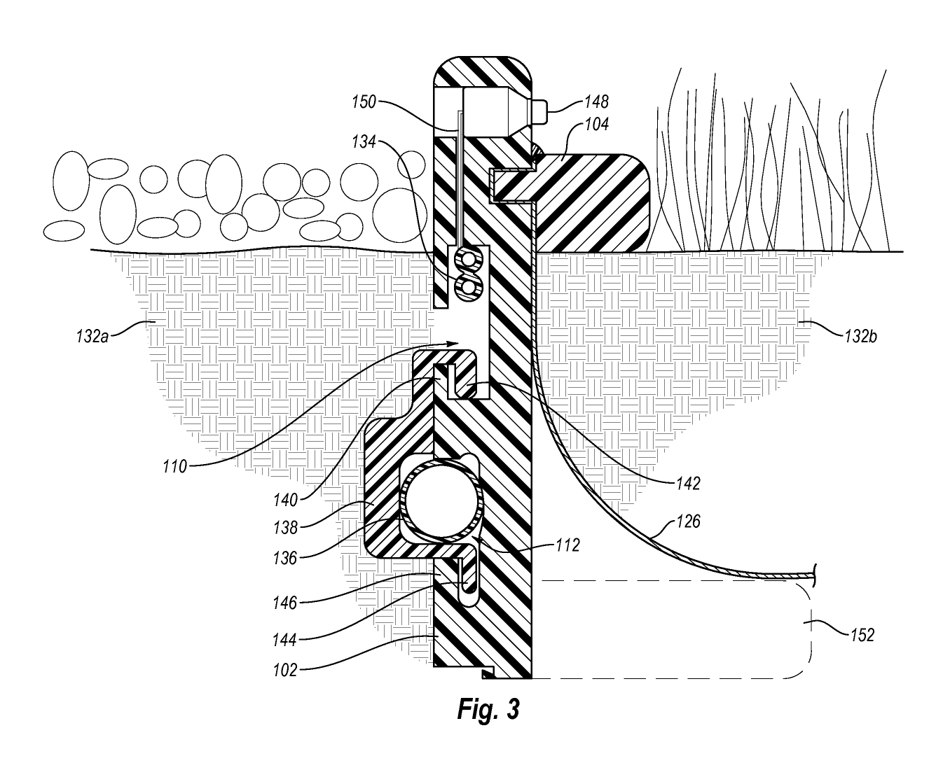

As illustrated in FIG. 1A, the first portion 102 can include a first portion back 106. The first portion back can have several features and elements to improve and enhance the landscape edging assembly 100. For example, the first portion back 106 can include a first channel 110. As will be discussed with respect to FIGS. 2 and 3, the first channel 110 can serve a variety of purposes and have variety of configurations. Generally speaking, the first channel 110 is positioned on the first portion back 106 such that when the first portion 102 is installed, the first channel 110 is below ground level. In alternative embodiments, the first channel 110 can be positioned in a higher or lower position on the first portion back 106.

As a further general description, the first channel 110 can be configured to house or otherwise integrate electrical wiring used in landscape lighting systems. The electrical wiring can be low-voltage wiring and be positioned within the first channel 110 to protect the electrical wiring as well as be used for a source of electricity to lighting components that can be integrated directly into the landscape edging assembly 100. This will be further described below with respect to FIGS. 2 and 3.

In addition to the first channel 110, the first portion back 106 can include a second channel 112 located below the first channel 110. Second channel 112 can serve a variety of purposes and have a variety of configurations. Generally speaking, the second channel 112 is positioned on the first portion back 106 such that when the first portion 102 is installed, the second channel is below ground level. In alternative embodiments, however, the second channel 112 can be positioned in a higher or lower position in the first portion back 106.

Generally, the second channel 112 can be configured to house or otherwise integrate irrigation system components used in landscape irrigation systems. For example, the second channel 112 can integrate water lines used to supply water to drip systems that water vegetation in flowerbeds proximate to the landscape edging system 100. This will be further described below with respect to FIGS. 2 and 3.

Although FIG. 1A illustrates the first portion back 106 has having a first channel 110 and a second channel 112, alternative embodiments of the first portion 102 can include a first portion back 106 with more or fewer channels. For example, in one example embodiment, the first portion back 106 has more than two channels, for example, three, four or more channels depending on the number of channel needs for a particular landscape project, and the height of the first portion 102. Alternatively, the first portion back 106 may not have any channels, and may simply be a substantially flat surface.

As further illustrated in FIG. 1A, the landscape edging assembly 100 can have a top surface. The top surface can be flat, as illustrated in FIG. 1A. In alternative embodiments, the first portion 102 and second portion 104 can be configured differently to produce various other aesthetic effects when combined. For example, the top surface of the landscape edge assembly 100 can include one or more steps or levels, can include a rounded feature, and/or other variations that provide a desired aesthetic to the portion above the ground.

As discussed above, the landscape edging assembly 100 further includes the second portion 104. The second portion 104 is configured to connect or otherwise attach to the first portion 102 such that a barrier 126 is secured to the first portion 102 and second portion 104 (as will be discussed in more detail below).

The second portion 104 can have various configurations and features. For example, the second portion 104 can have various cross-sectional geometric configurations. In one example embodiment, illustrated in FIG. 1A, the second portion 104 has a substantially square or rectangular cross-sectional geometric configuration. In alternative embodiments, the second portion can have a cross-sectional geometric configuration that is oval, triangular, and cylindrical or any other configuration or combination of configurations that is desired.

Similar to the first portion 102, the second portion 104 has a second portion back 108. As illustrated in FIG. 1A, the second portion back 108 is a substantially planar surface. However, in alternative embodiments, the second portion back 108 can have a non-planar configuration. For example, one or more decorative patterns may be manufactured into the second portion back 108, or one or more channels may be manufactured into the second portion back 108.

Moving through the Figures, FIG. 1B illustrates a front side view of the landscape edging assembly 100. As illustrated in FIG. 1B, the first portion 102 can include a first portion interface element 118. For example, and as shown in FIG. 1B, the first portion interface element 118 can be a substantially square or rectangular notch positioned substantially toward the upper half of the first portion 102. In alternative embodiments, the notch can have various different geometric configurations, for example, the notch can be substantially triangular, oval, or even have a customized geometric configuration that matches a second portion interface element 122 that is on the second portion 104. In one example, the first portion interface element 118 and the second portion interface element 122 can be configured to snap together to form a substantially permanent interlocking connection between the first portion and the second portion.

The position of the first portion interface element 118 can vary from one embodiment to the next. For example, FIG. 1B illustrates that the first portion interface element 118 is positioned substantially toward the upper half of the first portion 102. In alternative embodiments, the position of the first portion interface element 118 can vary depending on the desired connection with the second portion 104, the configuration of the second portion 104, and the desired aesthetic of the landscape edging assembly 100.

As briefly noted above, the second portion can include a second portion interface element 122. As illustrated in FIG. 1B, the second portion interface element 122 can be a protrusion that is configured to interface with the first portion interface element 118. The dimensions and geometric configuration of the second portion interface element 122 can vary from one embodiment to the next, as long as the first portion interface element 118 and second portion interface element 122 can securely attach to each other and secure the barrier 108 between the first portion 102 and the second portion 104.

FIG. 1B further illustrates and the second portion 104 has a second portion front 116. As illustrated in FIG. 1B, the second portion front 116 is a substantially planar surface. However, in alternative embodiments, the second portion front 116 can have a non-planar configuration. For example, one or more decorative patterns may be manufactured into the second portion front 116, or one or more channels may be manufactured into the second portion front 116.

In addition, FIG. 1B illustrates that breakaway cuts 120 can be manufactured for a dual purpose. One purpose is to create the second portion interface element 122. The second purpose of the breakaway cuts 120 is to allow the manufacture of the first portion 102 and second portion 104 from the same piece of raw material, and to provide an efficient and easy way for the removal of the first portion 102 from the second portion 104. Therefore, the breakaway cuts 120 can be positioned and sized to provide for a breakaway hinge 124 (shown on FIG. 1C).

As noted above, the breakaway cuts 120 and the breakaway hinge 124 allow the landscape edging assembly to be manufactured and shipped in a single piece. This provides a vastly superior landscape edging assembly compared to conventional style landscape edging, while at the same time maintaining the economy of a single piece manufacture and shipment.

In particular, the first portion 102 and second portion 104 can be connected together for purposes of manufacturing, shipping, and storing prior to installation. For example, the second portion 104 can be temporally attached or connected to the bottom portion of the first portion 102 by way of a breakable seam, or breakaway hinge 124, that can exist between the first portion 102 and second portion 104 due to the manufacturing process. For example, the manufacturing process can extrude the first portion 100 and second portion 200 as one piece, with a weakened and breakable seam existing between the first portion 100 and second portion 200.

By manufacturing the first portion 102 and the second portion 104 as a manufactured piece that is allowed to be separated at the landscape site, the manufacturing process is streamlined allowing for a more economical production of the landscape edging assembly 100 components. Moreover, shipping and storing prior to installation becomes much easier as the first portion 102 and second portion 104 will always be shipped, stored and sold with matching lengths. Always having the first portion 102 paired with a second portion 104 of equal length allows a landscaper to easily have the right amount of both the first portion 102 and second portion 104 to complete a landscape project.

FIGS. 1C through 1F illustrate how the first portion 102 and second portion 104 are removed from each other and then assembled. In particular, FIG. 1C illustrates that a landscaper can tilt or twist the second portion 104 at an angle with respect to the first portion 102. The breakaway cuts 120 provide clearance to allow the second portion 104 to be tilted. In addition, the breakaway hinge 124 is a piece of material left behind after the breakaway cuts 120 that allows the second portion 104 to remain securely attached to the first portion 102, but also allows the second portion 104 to be tilted. Depending on the type of material used for the landscape edging assembly 100, the exact dimensions of the breakaway hinge 124 can vary.

With increasing twisting force, a landscaper can break the breakaway hinge 124 and cause the first portion 102 and second portion 104 to be separated, as illustrated in FIG. 1D. As shown, once the second portion 104 is removed from the first portion 102, the second portion interface element 122 is now fully apparent and can be seen to correspond with the first portion interface element 118.

Shown in FIG. 1E, the landscaper can then align the second portion interface element 122 with the first portion interface element 118. Upon aligning the second portion interface element 122 with the first portion interface element 118, the landscaper can press the second portion 104 toward the first portion 102 and cause the second portion interface element 122 to interface with the first portion interface element 118. For example, as seen in FIG. 1F, the second portion interface element 122 is inserted into the first portion interface element 118. In the example shown in FIG. 1F, the inserting of the second portion interface element 122 may happen before or after installing the first portion 102 into the ground.

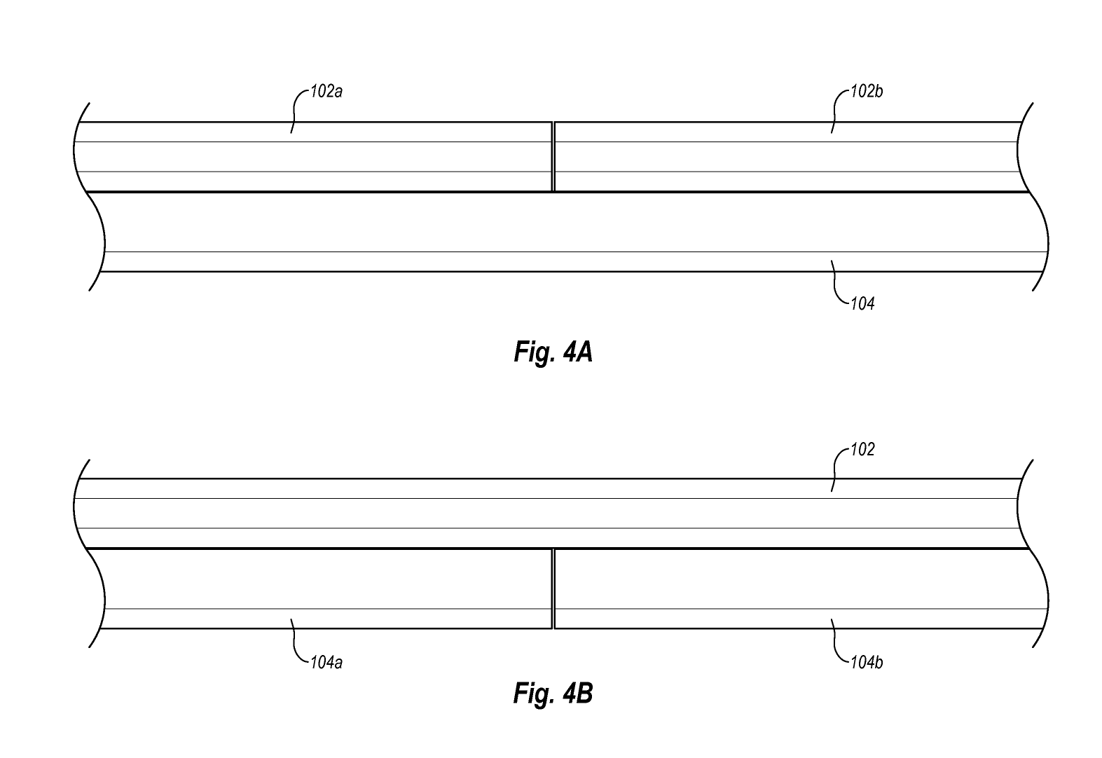

As shown in FIG. 1F, the second portion 104 provides a decorative edge or knuckle to the landscape edging assembly 100 that would not be possible otherwise. Compared to conventional edging devices that are simply a flat plane, the landscape edging assembly 100 has a more desirable and customized aesthetic. In addition, and as will be explained further below with reference to FIGS. 4A and 4B, the second portion 104 can overlap adjoining sections of first portions 102, thus creating a stronger and more stable landscape edging assembly 100 compared to conventional type edgings.

In addition to the steps and features described above, a barrier 126 can be installed between the first and second piece. For example, FIG. 2 illustrates an example embodiment of the landscape edging assembly 100 installed in an example landscape application. As illustrated, and discussed above, the landscape edging assembly 100 has a first portion 102 and a second portion 104. Installed and secured between the first portion 102 and the second portion 104 is a barrier 126. The purpose of the barrier 126 is to create a vegetation barrier between two landscape areas such that roots of vegetation from one landscape area do not enter another landscape area and produce unwanted vegetation or otherwise disturb the protected area. In alternative embodiments, a barrier 126 can further include the objectives of creating a bug/pest barrier, a water barrier, or other types of barriers depending on the location and needs of the landscaper.

As illustrated in FIG. 2, the bather 126 is shown in one example installation configuration. For example, and as illustrated in FIG. 2, the barrier 126 can be installed by running the barrier 126 down the first portion front 114, under the first portion 102, and under the first ground area 132a. In this way, the barrier 126 can form an effective weed barrier under mulch, decorative rocks, gravel, or other material, natural or otherwise, that is located in the first ground area 132a.

In addition to the installation configuration illustrated in FIG. 2, the barrier 126 can be installed in a variety of installation configurations. For example, FIG. 3 illustrates that the barrier 126 is installed under the second ground area 132b, thus forming a barrier below the roots of the grass growing on the second ground area 132b. In alternative embodiments, the barrier can be installed in a substantially vertical installation configuration for extended root zone protection. A combination of a vertical installation configuration and the configuration shown in FIG. 2 or 3 may also be employed where the barrier 126 is directed a vertical distance below the first portion 102 before transitioning to a horizontal direction under either the first or second ground areas 132a or 132b.

Depending on the purpose of the barrier 126, the bather 126 material may vary from on embodiment to the next. For example, the bather 126 can be made from a weed barrier cloth material that allows water to pass through the cloth, but does not allow vegetation to pass through the cloth. In other embodiments, the bather 126 material can be sheets of plastic, nylon, canvas, or any other type of material that may exhibit the properties needed to create an underground barrier. An ideal feature of any barrier 126 material is the ability to not biodegrade quickly while buried in the ground, thus providing a long lasting bather 126.

Notwithstanding the barrier 126 material, the length of the barrier 126 (e.g., the distance that the barrier extends underground) can vary from one embodiment to the next. For example, the barrier length can range from about six inches to about ten feet or more. There is no maximum on the length of the barrier 126 as the barrier 126 can be used to create a weed barrier for large areas of landscape.

As illustrated in FIG. 2, the barrier 126, in concert with the landscape edging assembly 100, can effectively and securely provide a barrier between a first ground area 132a and a second ground area 132b. For example, FIG. 2 illustrates that the first ground area 132a includes in part a rock bed, while the second ground area 132b includes grass. The barrier 126 effectively stops the roots of the grass in the second ground area 132b from entering the first ground area 132a. Due to the direct attachment of the barrier 126 to the landscape edging assembly, the barrier is secured to provide a long lasting and more effective barrier when compared to conventional edging and barrier systems.

Although not necessary, an attachment element 128 can be used to secure the first portion 102 to the second portion 104. For example, FIG. 2 illustrates that the attachment element 128 can be a screw that is positioned through the first and second portion interface elements 118 and 122, respectively. In this way, the first portion 102, the second portion 104, and the barrier 126 can all be connected via the attachment element 128. In alternative embodiments, the attachment element 128 can be various other mechanisms, including, but not limited to, a nail, a staple, bolt, peg, glue, etc.

In addition to the various types of attachment elements 112, the location in which the attachment element 128 is positioned within the landscape edging assembly 100 can vary. For example, FIG. 1B illustrates that the attachment element 128 can be positioned in the first and second portion interface elements 118 and 122 through the back side of the first portion 102. Alternatively, the attachment element 128 can be located above or below the first and second portion interface elements 118 and 122. Moreover, the attachment element may enter the assembly 100 through the top surface of the first portion 102, instead of the side, thus allowing easier access to position the attachment element 128 after installation of the assembly.

Depending on the position of the attachment element 128, the type of attachment element 128, and the type of materials used for the first and second portion 102 and 104, drill holes may be needed to avoid the material splitting when the attachment element 128 is used. In addition, the first portion 102 can include a countersink such that the attachment element 128 is flush with the first portion 102, thus further concealing the attachment element 128.

In addition to, or as an alternative to the attachment element 128, a bond element 130 may be used to secure the first portion 102 to the second portion 104. For example, as illustrated in FIG. 2, the bond element 130 is bonded in a location in which the bond element 130 interfaces with both the first portion 102 and the second portion 104. In particular, the bond element 130 is position on the upper corner interface, as illustrated in FIG. 2. In alternative embodiments, the bond element 130 can be positioned on the lower corner interface, or between the first portion interface element and the second portion interface element (not numbered in FIG. 2, but described above).

The bond element 130 can be made from any material that is able to adhere to the material of the landscape edging device 130. In one example embodiment, the bond element 130 is made of a material capable of creating a plastic weld. For example, the bond element can be a polyethylene plastic, or a plastic or material with similar properties. In the case of a plastic weld type material, the bond element 130 can be configured to be bonded in the field by way of a heat weld. In particular, a landscaper can position the bond element 130 in the desired location, and then heat the bond element 130 with a heat gun, blower, or similar device such that the bond element forms a substantially permanent adhesion with the landscape edging assembly 100. The bond element 130 may also be installed prior to shipping on preconfigured sections of the landscape edging assembly 100.

In addition to plastic weld type materials, the bond element 130 can be a wide variety of materials that physically or chemically interacts to form a substantially permanent bond between the bond element 130 and the landscape edging assembly 100. For example, the bond element 130 can be an adhesive, glue, tape, or other compound that will substantially permanently adhere to the material of the landscape edging assembly 100.

As is also illustrated in FIG. 2, the first channel 110 and second channel 112 are shown in one example of an installation of the landscape edging assembly 100. In particular, FIG. 2 illustrates the cross-sectional profile of the first channel 110 and the second channel 112. In alternative example embodiments, the cross-sectional profile of the first channel 110 and second channel 112 can vary depending on the use of the channel.

Furthermore, FIG. 2 illustrates the position of the first channel 110 and second channel 112 with respect to the ground level. As illustrated in FIG. 2, the opening of the first channel 110 and second channel 112 is located below the ground level to conceal the channel underground and provide a uniform aesthetic above ground. Moreover, the configuration of the first channel 110 illustrates how the opening of the first channel 110 can be located below ground level, but the interior portion of the first channel 110 actually can extend above ground level. In this way, the interior volume of the first channel 110 can be maximized, yet at the same time the uniform aesthetic above ground can be maintained. In alternative embodiments, the first channel 110 and/or second channel 112 may be located above ground level.

FIG. 3 illustrates a landscape edging assembly with various systems and components integrated as was summarized above. For example, FIG. 3 illustrates that an electrical wire 134 can be installed or otherwise integrated in the first channel 110. The electrical wire 134 can be installed in the upper interior portion of the first channel 110 such that the electrical wire 134 is protected from water and other elements. Although FIG. 3 illustrates only one electrical wire 134, other embodiments can include more than one electrical wire 134 integrated within the first channel 110.

FIG. 3 further illustrates a water line 136 integrated within the second channel 112. It is likely that a landscaper will want to run drip feeds away from the water line 136, and thus the water line is secured to the landscape edging assembly 100 with a retainer 138, as illustrated in FIG. 3. In alternative embodiments, or in sections of landscape edging where there is no need to access the water line 136, the water line 136 can be housed entirely within the second channel 112 (much like the electrical wire 134 discussed above with respect to the first channel 110).

The retainer 138 can be configured to interface with portions of the first channel 110 and second channel 112 such that no additional parts or tools are needed to attach the retainer 130 to the landscape edging assembly 100. For example, FIG. 3 illustrates that the retainer 138 can include a top retainer clip 142 and a bottom retainer clip 144. The top retainer clip 142 is sized and configured to interface with a first channel tab 140 such that the top retainer clip 142 is secured within the first channel 110. Similarly, the bottom retainer clip 144 is sized and configured to interface with a second channel tab 146 such that the bottom retainer clip 144 is secured within the second channel 112. In alternative embodiments, the retainer can be secured by way of an attachment element, bonding element, or otherwise.

The retainer element can be made of a material similar to the landscape edging assembly 100. The landscape edging assembly 100 can also be made from noncorrosive metals. It is advantageous that the retainer 138 be made of a material that can bend and flex. For example, the landscaper can insert the bottom retainer clip 144 into the second channel 112, and then flex and bend the top retainer clip 142 over the first channel tab 140 to secure the retainer 138 in place, as well as secure the water line 136 to the landscape edging assembly 100.

In addition to integrating the electrical wire 134 and the water line 136, FIG. 3 illustrates that the landscape edging assembly 100 can integrate a light device 148. As illustrated in FIG. 3, for example, the light device 148 can be integrated in the first portion 102. The light device 148 can be situated such that the light device 148 is located on the side of the landscape edging assembly 100, as illustrated in FIG. 3. Alternatively, the light device 148 can be situated such that the light device 148 protrudes from the top of the landscape edging assembly 100, or in the direction opposite of the direction shown in FIG. 3.

As illustrated in FIG. 3, a countersink hole can be formed into the top region of the first portion 102 such than the light device 148 can be pushed into the countersink hole and secured in place within the first portion 102. A cap (not shown) can be placed over the hole after installation if desired. In alternative embodiments, the light device 148 can be secured to the landscape edging assembly 100 through various methods. For example, the lighting device 148 can be secured with a clip, adhesive, mechanical retention device, or any combinations thereof.

In one embodiment, the light device 148 is an LED light. However, in alternative embodiments, the light device 148 can be incandescent, halogen, or any other type of light producing device. The landscape edging assembly 100 can include several light devices 148 spaced at distance from one another, thus creating a uniform lit landscape edging assembly. Or, alternatively, the light devices 148 installed in the landscape edging assembly 100 can be positioned to be spot lights on certain portions of the landscape area, as desired by the landscaper.

In order to power the light device 148, a jumper 150 can be connected between the light device 148 and the electrical wire 134 as illustrated in FIG. 3. For example, a small channel can be formed within the first portion 102 between the light device 148 and the electrical wire 134 to run the jumper 150. In this way, the jumper 150 is protected and hidden from view. The small channel can be formed during an extrusion, molding, or similar process to produce the interior channel. In one embodiment, the jumper 150 is a pair of electrically conductive pieces of material that are simply embedded within the first portion 102. Since the first portion 102 can be made from a non-electrically conductive material, the pieces of metal can act as a jumper 150 between the light device 148 and the electrical wiring 134.

In an alternative embodiment, the jumper 150 can be run along the first portion back 106 of the first portion 102, enter the first channel 110 through the slot in the first portion back 106, and then electrically connect to the electrical wire 134. In this way, a jumper can be installed in the field, allowing a landscaper to customize the exact location of the light device 148. In addition, the electrical wiring 134 can be connected to other jumpers or wires that are connected to lighting devices not located directly on the landscape edging assembly 100, but are part of a landscape lighting system.

FIG. 3 illustrates that the landscape edging assembly can optionally include a stabilizer 152. For example, depending on the height of the landscape edging assembly 100, it may be advantageous to add the stabilizer 152 to help secure the landscape edging assembly 100 in an upright position. The stabilizer 152 can extend perpendicularly any distance from the landscape edging assembly 100 such that the weight of the ground pressing down on the stabilizer 152 assists in keeping the landscape edging assembly 100 vertical indefinitely. The stabilizer 152 can be attached in segments along the landscape edging assembly 100 by attachment element(s) or bond element(s).

FIGS. 4A and 4B illustrate a top view of an example installed landscape edging assembly according to the present invention. As illustrated, when installed the landscape edging can include a plurality of landscape edging assembly sections that are adjoined together to form the installed landscape edging assembly. As shown in FIG. 4A, the installed landscape edging assembly can include a plurality of first portions 102a and 102b. The second portion 104 can be installed such that a single section of the second portion 104 overlaps the seam between the first portion 102a and the first portion 102b. In this way, sections of landscape edging assembly can easily be joined together to provide an installed landscape edging of any length.

Similarly, FIG. 4B illustrates a section of installed landscape assembly. As illustrated, FIG. 4B shows how a single first portion 102 can be installed such that a single section of the first portion 102 overlaps the seam between the second portion 104a and the second portion 104b. In this way, section of landscape edging assembly can easily be joined to provide an installed landscape edging of any length.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A landscape edging assembly, comprising:
a first portion;
a first portion interface element formed within the first portion;
a second portion;
a second portion interface element formed within the second portion and interfaces with the first portion interface element; and
a barrier that is secured between the first portion interface element and the second portion interface element.

2. The landscape edging assembly recited in claim 1, wherein the first portion interface element is a substantially rectangular channel.

3. The landscape edging assembly recited in claim 2, wherein the second portion interface element is a substantially rectangular protrusion.

4. The landscape edging assembly recited in claim 1, further comprising a first channel formed within the first portion.

5. The landscape edging assembly recited in claim 4, wherein the first channel is configured to house an electrical wire.

6. The landscape edging assembly recited in claim 5, further comprising a second channel formed within the first portion.

7. The landscape edging assembly recited in claim 6, wherein the second channel is configured to house a water line.

8. The landscape edging assembly recited in claim 7, further comprising a retainer that attaches to the first portion and assists to secure the water line within the second channel.

9. The landscape edging assembly recited in claim 8, wherein the retainer comprises:
a top retainer clip that interfaces with a first channel tab of the first channel; and
a bottom retainer clip that interfaces with a second channel tab of the second channel.

10. The landscape edging assembly recited in claim 1, further comprising an attachment element that secures the first portion to the second portion.

11. A landscape edging assembling, comprising:
a first portion having a first portion back and a first portion front; and
a light device attached to the first portion.

12. The landscape edging assembly recited in claim 11, further comprising at least one channel formed into the first portion.

13. The landscape edging assembly recited in claim 12, further comprising an electrical wire at least partially within the first channel.

14. The landscape edging assembly recited in claim 13, wherein the light device and the electrical wire are in electrical communication.

15. The landscape edging assembly recited in claim 14, further comprising a jumper positioned between the light device and the electrical wire to provide the electrical communication.

16. A method of assembling a landscape edging assembly, comprising:
obtaining a first portion having a first interface element;
obtaining a second portion having a second interface element;
aligning the first interface element with the second interface element;
positioning a barrier between the first interface element and the second interface element; and
causing the first interface element to engage the second interface element whereby the barrier is secured between the first interface element and second interface element.

17. The method recited in claim 16, further comprising securing an attachment element to the first interface element and the second interface element.

18. The method recited in claim 16, further comprising bonding the first portion to the second portion with a bond element.

19. The method recited in claim 18, further comprising integrating a waterline at least partially within a channel formed within the first portion.

20. The method recited in claim 18, further comprising integrating an electrical wire at least partially within a channel formed within the first portion.
